(19) United States
(12) Patent Application Publication
(10) Pub. No.: US 2012/0244053 A1
(43) Pub. Date: Sep. 27, 2012

(54) STAGED ABSORBER SYSTEM AND METHOD

(76) Inventors: KYLE SELF, San Jose, CA (US); Betty Kong Ling, San Jose, CA (US); Riyaz Shipchandler, Campbell, CA (US)

(21) Appl. No.: 13/407,429

(22) Filed: Feb. 28, 2012

Related U.S. Application Data
(60) Provisional application No. 61/467,528, filed on Mar. 25, 2011.

(51) Int. Cl. B01D 53/62

(52) U.S. Cl. 423/220; 422/170

(57) ABSTRACT

Provided are methods for sequestering carbon dioxide. A recovery method and system for recovering a gaseous component is provided. Methods and systems may utilize one or more absorbing solutions in two or more absorbing zones. Methods for reducing the volume of an absorbing system are described. Methods for adjusting the composition of sequestered carbon dioxide are provided.

### CROSS-REFERENCE TO RELATED APPLICATION

This application claims priority to U.S. Provisional Application No. 61/467,528, filed Mar. 25, 2011, which is incorporated herein by reference in its entirety.

### BACKGROUND

Methods and systems to maximize carbon sequestration are needed. Improved methods and systems for contacting gases and liquid may increase overall carbon sequestration from a gas. Improved methods and systems for gas-liquid contact are needed to insure that the carbon sequestration methods are economical.

### SUMMARY

Provided are methods for contacting a gas and a liquid that comprise contacting an incoming gas comprising carbon dioxide at a first concentration with a first alkaline solution under conditions promoting an acid-base reaction between the carbon dioxide and the first alkaline solution to form a first product solution and an intermediate gas comprising carbon dioxide at a second concentration that is less than the first concentration followed by contacting the intermediate gas with a second alkaline solution under conditions that promote an acid-base reaction between the carbon dioxide and the second alkaline solution to form a second product solution and a product gas wherein the product gas comprises less carbon dioxide than the intermediate gas. In some embodiments the pH of the second alkaline solution is greater than the pH of the first alkaline solution. In some embodiments the first or second solution comprises a component for sequestering NOₓ, SOₓ, Hg, ammonia, hydrogen chloride or any combination thereof. In some embodiments the first and second solutions do not contain amines. In some embodiments the contacting of the incoming gas and the intermediate gas may occur in the same or a different reaction vessel. In some embodiments a precipitation material may be formed from the first, second or both of the product solutions. In some embodiments a precipitation material may be formed by contacting the first or second product solution with a carbonate solution or a solution comprising divalent cations or any combination thereof. In some embodiments a precipitation material may be formed by adjusting the pH of the first or second product solution. In some embodiments a precipitation material may be formed by adjusting the temperature of the first or second product solution. In some embodiments the first and second alkaline solution may be provided by a first and second electrochemical reaction. In some embodiments the first and second electrochemical reactions may not produce a gas (e.g., chlorine) at the anode. In some embodiments a portion of the first alkaline solution may be transferred from the first electrochemical reaction to the second electrochemical reaction. In some embodiments the first product solution may contain carbonate, bicarbonate, carbon dioxide or any combination thereof. In some embodiments the second product solution may contain carbonate, bicarbonate, carbon dioxide or any combination thereof. In some embodiments the first or second alkaline solution may contain sodium hydroxide or carbonate ions or any combination thereof. In some embodiments the first alkaline solution may have a pH of between 7 and 10. In some embodiments the second alkaline solution may have a pH of between 9 and 14. In some embodiments the first product or second product solution has a pH greater than 7. In some embodiments the precipitation material of this invention may comprise vaterite, aragonite, amorphous calcium carbonate or any combination thereof. In some embodiments the method of this invention may include contacting a third alkaline solution (that has a pH higher than the pH of the first solution) with the product gas, to form a third product solution comprising carbonate, bicarbonate, carbon dioxide or any combination thereof. In some embodiments the first electrochemical reaction forming the first alkaline solution may include oxidizing hydrogen to protons at a hydrogen-oxidizing anode in communication with a cathode electrolyte and sequestering carbon dioxide with the cathode electrolyte. In some embodiments the second electrochemical reaction may comprise oxidizing hydrogen to protons at a hydrogen-oxidizing anode in communication with a cathode electrolyte and sequestering carbon dioxide with the cathode electrolyte.

In some embodiments a system of this invention may include a gas liquid absorber comprising a first and second absorbing zone and where the first absorbing zone may be adapted to withstand alkaline conditions. The gas liquid absorber (e.g., the first absorbing zone) may be operably connected to a source of gas comprising carbon dioxide and a source of a first alkaline solution and wherein the zone is configured contact a source of gas comprising carbon dioxide with the first solution to form a first product solution and an intermediate gas comprising carbon dioxide and wherein the first zone comprises a first gas outlet for the intermediate gas and a first solution outlet for the first product solution. In some embodiments the second absorbing zone may be adapted to withstand alkaline conditions and be operably connected the to the outlet for the intermediate gas and a source of a second alkaline solution wherein the second zone may be configured contact the intermediate gas comprising carbon dioxide with the second alkaline solution to form product gas and a second product solution and wherein the second absorbing zone comprises a second gas outlet for the product gas and a second solution outlet for the second product solution. In some embodiments the first solution outlet may be operably connected to a precipitation station. In some embodiments the second solution outlet may be operably connected to a precipitation station. In some embodiments a first and second pump may be connected to the gas-liquid absorber and the first pump may be operably connected to the first source of alkaline solution and the second pump may be operably connected to the second alkaline solution. In some embodiments the first absorbing zone may be a packed bed. In some embodiments the second absorbing zone may be a packed bed. In some embodiments the system may include a first electrochemical system for providing the first alkaline solution and operably connected to the first absorbing zone. In some embodiments the system may include an electrochemical system for providing the second alkaline solution and operably connected to the second absorbing zone. In some embodiments the first and second electrochemical systems may be in fluid communication outside of the absorber. In some embodiments the first electrochemical system may comprise a hydrogen oxidizing anode in communication with a cathode electrolyte wherein the electrochemistry unit is operably connected to the carbon sequestration system configured to sequester carbon dioxide with the cathode electrolyte. In some embodiments cathode electrolyte comprises added carbon dioxide. In some embodiments the cathode electrolyte may comprise hydroxide ions, carbonates ions or any combination thereof.

### DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a flow diagram depicting an embodiment of the invention.

FIG. 2 shows a schematic diagram depicting the path of solutions into and out of an embodiment of an absorber of this invention.

FIG. 3 shows a schematic diagram depicting the path of solutions into and out of an embodiment of an absorber of this invention including an electrochemical system.

FIG. 4 shows a schematic diagram depicting the path of solutions into and out of an embodiment of an absorber of this invention including an electrochemical system.

FIG. 5 shows a schematic diagram depicting the path of solutions into and out of an embodiment of an absorber of this invention including an electrochemical system.

FIG. 6 depicts an embodiment of an electrochemical system of this invention.

### DESCRIPTION

Methods and systems are disclosed for the sequestration of carbon dioxide from an incoming gas. In some embodiments the methods and systems disclosed provide for an absorber system and method wherein at least two solutions are used to sequester carbon dioxide in at least two different absorbing zones in a gas liquid contacting system. The solutions may utilize an acid-base reaction in order to sequester the carbon dioxide. In some embodiments, the first carbon sequestering solution may be less alkaline than the second carbon sequestering solution. In some embodiments the solutions contain no amines. In some embodiments, one or more of the absorbing solution may contain additional components for removing other components of the incoming gas. The two or more absorbing solutions used to sequester carbon dioxide in two or more absorbing zones may lower the overall energy needed to sequester carbon dioxide from an incoming gas. The absorbing solutions may be generated by electrochemical methods and systems that in some cases may be utilized carbon dioxide sequestered from the incoming gas.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

Materials used to produce compositions of the invention are described in a section with particular attention to sources of CO₂, divalent cations, and proton-removing agents (and methods of effecting proton removal). A description of systems that may be used to sequester carbon dioxide is also provided. Methods for generating reactive carbon sequestering solutions are provided. Methods by which materials (e.g., CO₂, divalent cations, etc.) may be incorporated into compositions of the invention are described next. Subject matter is organized as a convenience to the reader and in no way limits the scope of the invention.

### Sequestration of Carbon Dioxide

As described in commonly assigned U.S. patent application Ser. No. 12/344,019 supra, herein incorporated by reference in its entirety, carbon dioxide may be sequestered by dissolving the gas in an aqueous solution Eq. I to produce aqueous carbon dioxide. This may be converted to carbonic acid, which will dissociate into bicarbonate ions and carbonate ions in accordance with Eq. II, depending on the pH of the solution when hydroxide ions are added to the solution Eq. III. The conversion of carbonic acid into bicarbonate and carbonate may be accomplished through the addition of a proton-removing agent (e.g., a base) (III-IV). Chemically, aqueous dissolution of CO₂ may be described by the following set of equations:

CO₂ (g)⇄CO₂ (aq) (in the presence of water) (I)

CO₂ (aq)+H₂O⇄H₂CO₃ (aq) (II)

Conversion to bicarbonate may described by the following equations:

H₂CO₃ (aq)+OH⁻ (aq)⇄HCO₃⁻ (aq)+H₂O (III)

CO₂ (aq)+OH⁻ (aq)⇄HCO₃⁻ (aq) (IV)

In the methods described herein, at least some of the captured carbon dioxide may be converted to bicarbonate or carbonate ions through the addition of proton-removing agents.

As described in detail below, contacting the alkaline solution with a source of CO₂ may employ any suitable protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention also include methods for contacting a solution with an incoming gas gas comprising carbon dioxide to produce a carbon containing reaction product (e.g., an aqueous solution comprising carbonic acid, bicarbonate, carbonate or combination thereof) and an intermediate gas that may be contacted again with a another absorbing solution to form another reaction product. The reaction products may be a clear liquid or a precipitate. In some embodiments the reaction products may be combined or kept separate. In some embodiments of methods of this invention, the incoming gas comprises CO₂ at levels greater than those found in the atmosphere. The incoming gas comprising CO₂ at levels greater than those found in the atmosphere may be contacted with a first and second aqueous mixture. The absorbing solutions may be alkaline solutions. In certain embodiments of the invention, a portion of any reaction product produced by contacting carbon dioxide with an alkaline solution may be further placed in a location (e.g., in a in a subterranean site), effectively sequestering carbon dioxide in the form of any combination of a carbonic acid, bicarbonate and carbonate mixture. Alternatively, or in addition to sequestering the reaction product, the carbonic acid, bicarbonate, carbonate, carbonate composition may further be contacted with a source of one or more proton-removing agents and/or a source of one or more divalent cations to produce a precipitated material comprising carbonates and/or bicarbonates. In some embodiments the reaction product may be further contacted with carbon dioxide to sequester a second portion of carbon dioxide. A portion of the reaction product material may be placed in a subterranean site or used as a commercial product (e.g., a building material). In some embodiments sequestering the reaction product may comprise placing the reaction product in a subterranean location.

“Alkaline solution” as used herein includes an aqueous composition which possesses sufficient alkalinity to remove one or more protons from proton-containing species in solution. Proton removing agents are discussed in greater detail below. The stoichiometric sum of proton-removing agents in the alkaline solution exceeds the stoichiometric sum of proton-containing agents expressed as equivalents or milliequivalents (mEq.). In some instances, the alkaline solutions of this invention have a pH that is above neutral pH (i.e., pH>7), e.g., the solutions may have a pH ranging from 7.1 to 12, such as 8 to 12, such as 8 to 11, and including 9 to 14. For example, the pH of one or more alkaline of the solution may be 9.5 or higher, such as 9.7 or higher, including 10 or higher. Contact of gases or liquids comprising carbon dioxide with a solution of this invention may convert the carbon dioxide to storage stable form such as a composition comprising carbonate, bicarbonate or any combination thereof.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra hereby incorporated by reference in its entirety.

### Materials

As described in further detail below, the invention involves the use of one or more of a source of CO₂, and one or more sources of alkalinity. The materials may be used to produce compositions comprising carbonates, bicarbonates, or combinations thereof.

### Carbon Dioxide

In some embodiments, methods of the invention include contacting a reactive first solution with a gas comprising carbon dioxide to form a product second solution comprising water, carbonic acids, dissolved carbon dioxide, bicarbonates, or carbonates, or any combination thereof. This may be followed by contacting the gas with a reactive third solution to capture carbon dioxide not captured by the first solution to form a product fourth solution comprising water, carbonic acids, dissolved carbon dioxide, bicarbonates, or carbonates, or any combination thereof. The second and fourth solutions may be the same or different. The first solution may have a lower pH than the third solution. In some embodiments, the resultant product solutions may subject to conditions that induce precipitation of a precipitation material. The source of CO₂ may be any suitable source in any suitable form including, but not limited to, a gas, a liquid, a solid (e.g., dry ice), a supercritical fluid, and CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulate material. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, smelters, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, smelters, and coal processing plants is used.

Thus, the waste streams may be produced from a variety of different types of industrial plants. Suitable waste streams for the invention include waste streams produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

While industrial waste gas streams suitable for use in the invention contain carbon dioxide, such waste streams may, especially in the case of power plants that combust carbon-based fuels (e.g., coal), contain additional components such as water (e.g., water vapor), CO, NOₓ (mononitrogen oxides: NO and NO₂), SOₓ (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Flue gas temperature may also vary. In some embodiments, the temperature of the flue gas is from 0° C. to 2000° C., such as from 60° C. to 700° C., and including 100° C. to 400° C.

### Alkaline Solutions

In some embodiments, methods of the invention include contacting a volume of two or more reactive solutions with a source of CO₂ to form product solutions comprising carbonic acid, bicarbonate, carbonate, dissolved carbon dioxide or any combination thereof. The product solutions may be converted to compositions including precipitates or slurries. The reactive solutions may be alkaline. The reactive solutions may be comprised of the same or a different proton removing alkaline component. In some embodiments the alkaline component of a first reactive solution is carbonate ions and the alkaline component of a second reactive solution may be hydroxide ions. The first and second reactive solutions may have different pHs. The first reactive solution may have a pH lower than the second reactive solution. The first reactive solution may have a pH greater than 7 such as greater than 8 or greater than 9 or greater than 10. The second solution may have a pH greater than 8 such as greater than 9 or greater than 10 or greater than 11 or greater than 12 or greater than 13.

The reactive solutions of this invention may comprise chemical agents. Chemical agents for effecting proton removal generally refer to synthetic chemical agents produced in large quantities and are commercially available or electrochemically synthesized. For example, chemical agents for removing protons include, but are not limited to, hydroxides, organic bases, super bases, oxides, ammonia, borates and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). In some embodiments, the chemical proton-removing agent may be an organic base. In some instances, the organic base may be a monocarboxylic acid anion, e.g., formate, acetate, propionate, butyrate, and valerate, among others. In other instances, the reactive organic species may be a dicarboxylic acid anion, e.g., oxalate, malonate, succinate, and glutarate, among others. In other instances, the organic base may be a phenolic compound, e.g., phenol, methylphenol, ethylphenol, and dimethylphenol, among others. In some embodiments, the organic base may be a nitrogenous base, such as ammonia or a primary amine, e.g., methyl amine, a secondary amine, e.g., diisopropylamine, a tertiary amine, e.g., diisopropylethylamine, an aromatic amine, e.g., aniline, or a heteroaromatic, e.g., pyridine, imidazole, or benzimidazole. In some embodiments, the proton-removing agent is a super base. Suitable super bases may include, but are not limited to sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) may be also suitable proton-removing agents that may be used.

In addition to including cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g., iron slag, phosphorous slag); cement kiln waste; oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining may be used to modify pH, wherein the waste is selected from red mud from the Bayer aluminum extraction process; waste from magnesium extraction from seawater (e.g., Mg(OH)₂ such as that found in Moss Landing, Calif.); and wastes from mining processes involving leaching. For example, red mud may be used to modify pH. Fossil fuel burning ash, cement kiln dust, and slag, collectively waste sources of metal oxides may be used in alone or in combination with other proton-removing agents to provide proton-removing agents for the invention. Agricultural waste, either through animal waste or excessive fertilizer use, may contain potassium hydroxide (KOH) or ammonia (NH₃) or both. As such, agricultural waste may be used in some embodiments of the invention as a proton-removing agent. This agricultural waste is often collected in ponds, but it may also percolate down into aquifers, where it may be accessed and used.

In some instances, electrochemical methods may employed to remove protons from various species in the first or second or both solutions, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods may be used to remove protons, for example, as CO₂ is dissolved in the reaction mixture or a precursor solution to the reaction mixture. In some embodiments, CO₂ dissolved in solution may be treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas may be convenient for use in systems and methods of the invention. Low-voltage electrochemical methods to remove protons that do not generate oxygen gas may also be convenient for use in systems and methods of the invention. In some embodiments the invention may utilize a low-voltage electrochemical method that produces no gas at the anode. In some embodiments the invention may utilize low-voltage electrochemical methods that consume hydrogen at the anode; in some of these embodiments, no gas is produced at the anode. In some embodiments, low-voltage electrochemical methods generate hydrogen gas at the cathode and transport it to the anode where the hydrogen gas is converted to protons. Electrochemical methods that do not generate hydrogen gas may also be convenient. In some instances, electrochemical methods to remove protons do not generate any gaseous by-byproduct. Electrochemical methods for effecting proton removal are further described in U.S. patent application Ser. No. 12/344,019, filed 24 Dec. 2008; U.S. patent application Ser. No. 12/375,632, filed 23 Dec. 2008; International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; and U.S. patent application Ser. No. 12/541,055, filed 13 Aug. 2009, each of which are incorporated herein by reference in their entirety.

Alternatively, electrochemical methods may be used to produce caustic molecules (e.g., hydroxide) through, for example, the chlor-alkali process, or modification thereof. Electrodes (i.e., cathodes and anodes) may be present in the apparatus containing a brine or gaseous waste stream-charged (e.g., CO₂-charged) solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. Provisional Patent Application No. 61/081,299, filed 16 Jul. 2008, and U.S. Provisional Patent Application No. 61/091,729, the disclosures of which are incorporated herein by reference.

### Methods

It will be appreciated that some sources of alkalinity contain carbonates, e.g., sodium carbonates. In such methods, a reaction may be carried out in which carbon dioxide is added to carbonate source of alkalinity, resulting in the formation of bicarbonate:

Na₂CO₃+CO₂+H₂O→2NaHCO₃

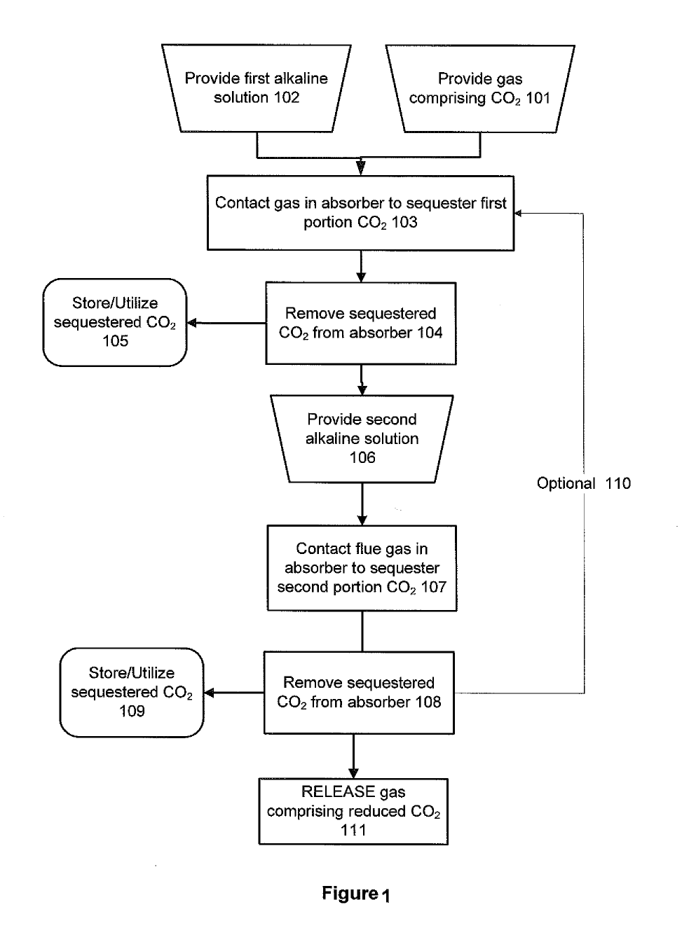

In some embodiments an alkaline solution or an electrochemical reaction may be used to sequester a portion of carbon dioxide into a solution comprising carbonates, bicarbonates or any combination thereof. In such a system, a solution of sequestered carbon dioxide solution may contain sufficient alkalinity to sequester a second portion of CO₂. In some embodiments a portion of carbon dioxide may be converted (i.e., by contacting the carbon dioxide with an alkaline solution) to carbonates and the carbonate solution may be contacted with a second portion of carbon dioxide in addition to another source of alkalinity (e.g., hydroxide, carbonate). Thus, in some embodiments the invention as illustrated in FIG. 1 provides a method of sequestering carbon dioxide by providing contacting a gas comprising of carbon dioxide 101 and an aqueous solution of sufficient alkalinity 102 (e.g., an alkaline brine or an alkaline solution generated from an electrochemical reaction), to generate a solution that sequesters a portion (i.e., over 10, 20, 30, 40, 50, 60, 70, 80, 90, 95, 99%) of the carbon dioxide 103 in a product solution that comprises bicarbonate carbonates, or any combination thereof. The product solution may be removed 104 for storage or utilization 105. A second alkaline solution comprising sufficient alkalinity (e.g., hydroxide, carbonate alkalinity) may be provided 106 to contact the gas carbon dioxide containing gas again 107 and convert over 10, 20, 30, 40, 50, 60, 70, 80, 90, 95, or 99% of the remaining carbon dioxide to a sequestered form 108. The second portion of sequestered carbon dioxide may be stored or utilized 109 or optionally cycled back into the carbon sequestration system 110. Flue gas with a reduced carbon dioxide composition may be released 111.

Some or all of the sequestered carbon dioxide may be disposed of, e.g., by injection into a subterranean location, in may be any suitable location. In some embodiments over 10, 20, 30, 40, 50, 60, 70, 80, 90, 95, 99% of the sequestered carbon dioxide product formed, or 100% of the sequestered carbon dioxide product formed, may be disposed of this way. Alternatively, or in addition, some portion of the sequestered carbon dioxide may be further treated, e.g., with a base or additional carbonate or a divalent cation, to form a precipitate. In some embodiments one or more divalent cations, such as magnesium and/or calcium, may be present and a carbonate of the divalent cation may form, e.g., calcium or magnesium carbonate; typically such a carbonate of the divalent cation will precipitation from the solution. It will be appreciated that in such a system one mole of base (e.g., hydroxide) may be used to produce one mole of carbonate (e.g., magnesium and/or calcium carbonate). The amount of base added may be any desired amount, so that any proportion, from 0 to 100%, of the original carbon dioxide that is sequestered in the aqueous solution may be converted to carbonate and the remainder, (100-0) % remains in the form of bicarbonate, in a process using base for the final conversion to carbonate in a ratio of 1 equivalent of base per each mole of carbonate produced. For example an amount of base may be added sufficient to result in carbonate and bicarbonate in a final molar % ratio of bicarbonate:carbonate of from 0.1:99.9 to 99.9:0.1, or 1:99 to 99:1, or 10:90 to 90:10, or 20:80 to 80:20, or 30:70 to 70:30, or 40:60 to 60:40, or about 50:50. By way of illustration only, in a system or method in which 10 moles of carbon dioxide are dissolved in a carbonate solution, e.g., to produce 20 moles of bicarbonate (10 moles from the original carbonate and 10 moles from the dissolved carbon dioxide), an additional 5 moles of NaOH (5 equivalents) may be added together with at least 5 moles of calcium and/or magnesium ion, which converts 5 moles of the bicarbonate to insoluble calcium and/or magnesium carbonate and leaves 15 moles of bicarbonate in solution (a 75:25% ratio of bicarbonate to carbonate). Thus, in some embodiments the invention provides a method of treating a gas containing carbon dioxide by contacting the gas with a first aqueous alkaline solution, e.g., sodium carbonate, hydroxide, to produce a bicarbonate and or carbonate solution from the carbon dioxide, followed by treatment of the remaining gas with a second aqueous alkaline solution. The systems and methods of this invention beneficially provide for regulating the amount and composition of sequestered carbon dioxide products.

In some embodiments a product solution of this invention may comprise bicarbonate. The bicarbonate product of this invention may be stored or converted into a useful product. In some embodiments the bicarbonate solution may be treated with an amount of base, e.g., hydroxide, and divalent cation, e.g., calcium or magnesium ion, sufficient to convert a portion of the bicarbonate thus produced to an insoluble carbonate, e.g., magnesium and/or calcium carbonate. The ratio of bicarbonate and carbonate in the final product may be varied depending on any suitable factor, such as the availability and/or cost of base, so that, e.g., more carbonate may be produced when base is cheaper and less when base is more expensive; the system or method may be set up to automatically adjust the ratios according to one or more criterion such as base cost, amount of electricity available to produce base, demand for carbonate products, and the like. The insoluble carbonate may be further treated, as describe herein, e.g., to produce materials useful in building and construction. In some embodiments a portion of the alkaline solution may be used to convert sequester carbon dioxide in a solution comprising bicarbonate. A portion of the bicarbonate solution may be converted to a solution comprising carbonate by an electrochemical method, e.g., a low-voltage electrochemical method such as a method wherein a voltage is applied across an anode and a cathode, and hydrogen gas is produced at the cathode and consumed at the anode, and hydroxide is produced at the cathode and protons at the anode. The carbonate solution may be used to sequester still more carbon dioxide. Combinations of any of the above mentioned sources of proton-removing agents and methods for effecting proton removal may also be employed.

As reviewed above, methods of the invention include contacting a first alkaline solution with a source of carbon dioxide to produce a first product solution. In some embodiments, an alkaline first solution of this invention may possess sufficient alkalinity (i.e., a pH ranging between 7 to 11, such as 9 to 10.5, including 9 to 10) to convert a portion of the carbon dioxide to a CO₂-sequestered storage stable composition (e.g., bicarbonate, carbonate or any combination thereof). In these embodiments, the product solution may be considered a CO₂ sequestering storage stable composition. The invention further provides for contacting the source of carbon dioxide with a second alkaline solution with sufficient (and optionally higher) alkalinity (i.e., a pH ranging between 9 to 14, such as 10 to 13, including 12 to 13) so that a second portion of carbon dioxide may be converted to a CO₂ sequestered storage stable second product solution (e.g., bicarbonate, carbonate or any combination thereof). In some embodiments the second alkaline solution may be contacted with the carbon dioxide at a higher point in a vertical absorption vessel than the first alkaline solution. The method advantageously may sequester a portion of CO₂ in a first storage stable form using relatively lower alkalinity and then utilize a higher alkalinity solution to sequester a second portion of carbon dioxide in a second storage stable form, thus lowering the overall energy cost of the carbon sequestration and providing a means to regulate the composition of two sequestered carbon dioxide products (e.g., bicarbonate:carbonate ratio of the sequestered carbon dioxide) and to lower the volume (and therefore energy) of a sequestering solution at a higher height. The volume (or overall alkalinity) of the alkaline second solution may be lower because the first solution contacting carbon dioxide may sequester a sufficient portion of carbon dioxide needed to minimize the volume of the second alkaline solution.

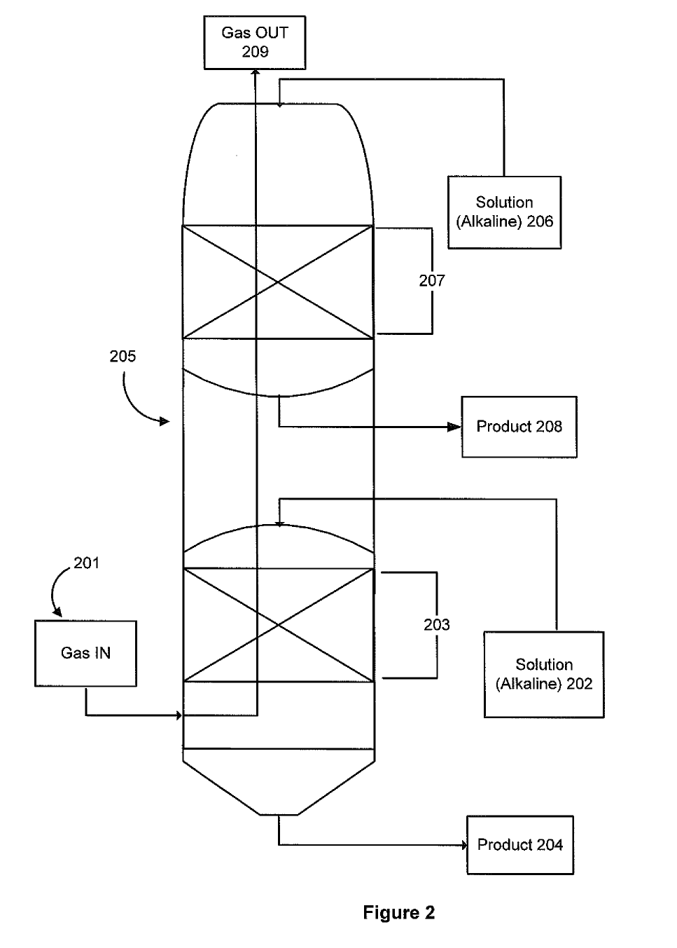

An embodiment of this invention is illustrated in FIG. 2. A gas comprising carbon dioxide 201 may be contacted with an alkaline first solution 202 in a first zone 203. The contacting may result in an acid base reaction that generates a product solution 204 comprising sequestered carbon dioxide. In some embodiments the product solution 204 may comprise carbonate, bicarbonates or any combination thereof. In some embodiments the bicarbonate:carbonate ratio of the product solution may be greater than 1:1, 10:1, 100:1, or 1000:1. The sequestered carbon dioxide may be stored or utilized in a precipitation reaction. The gas containing unreacted carbon dioxide may continue through the reaction vessel 205 and contact a second alkaline solution 206 in a second zone 207. In some embodiments the second alkaine solution may have a higher pH than the first alkaline solution and therefore sequester carbon dioxide at a lower partial pressure. In some embodiments a portion of carbon dioxide is sequestered in a second product solution 208. In some embodiments the bicarbonate:carbonate ratio of the second solution may be less than 1:1, 1:10, 1:100, or 1:1000. The sequestered carbon dioxide in the fourth solution 208 may be separated from the absorption system and stored or utilized in a precipitation reaction. In some embodiments the second product solution may have sufficient alkalinity to sequester additional carbon dioxide as bicarbonate as it contacts carbon dioxide in the first zone. Gas with a reduced carbon dioxide composition 209 may be released or transferred to another location.

By “CO₂ sequestering storage stable composition” is meant a product that removes or segregates an amount of CO₂ from an environment, such as the Earth's atmosphere or a gaseous waste stream produced by an industrial plant, so that some or all of the CO₂ is no longer present in the environment from which it has been removed. By “storage stable” is meant a form that can be stored, for example above ground or underwater, under exposed conditions (for example, open to the atmosphere, underwater environment, etc.), without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or 100,000,000 years or longer, or 1,000,000,000 years or longer. As the storage stable form undergoes little if any degradation, the amount of degradation if any as measured in terms of CO₂ gas release from the product will not exceed 5%/year, and in certain embodiments will not exceed 1%/year or 0.001% per year. CO₂ sequestering methods of the invention sequester CO₂ producing a storage stable carbon dioxide sequestering product from an amount of CO₂, such that the CO₂ from which the product is produced is then sequestered in that product. The storage stable CO₂ sequestering product is a storage stable composition that incorporates an amount of CO₂ into a storage stable form, such as an above-ground storage or underwater storage stable form, so that the CO₂ is no longer present as, or available to be, a gas in the atmosphere. The sequestered carbon dioxide solutions, which include sequestered CO₂ bicarbonate, carbonate, carbonic acid or any combination thereof, may, in some embodiments, be transported to a location for long-term storage, effectively sequestering the CO₂. For example, the CO₂-sequestered storage stable reaction mixture may be transported and placed at long term storage sites, e.g., above ground, below ground in the deep ocean, or as desired.

### Electrochemical Methods

Electrochemical methods are another means to remove protons from various species in a solution. Electrochemical methods may be used to produce caustic molecules (e.g., hydroxide) through, for example, the chlor-alkali process, or modifications thereof. In some embodiments electrochemical systems and methods for removing protons may produce an acidic solution in a separate compartment that may be harvested and used for other purposes. Additional electrochemical approaches that may be used in systems and methods of the invention include, but are not limited to, those described in U.S. patent application Ser. No. 12/344,019, filed 24 Dec. 2008; U.S. patent application Ser. No. 12/375,632, filed 23 Dec. 2008, International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

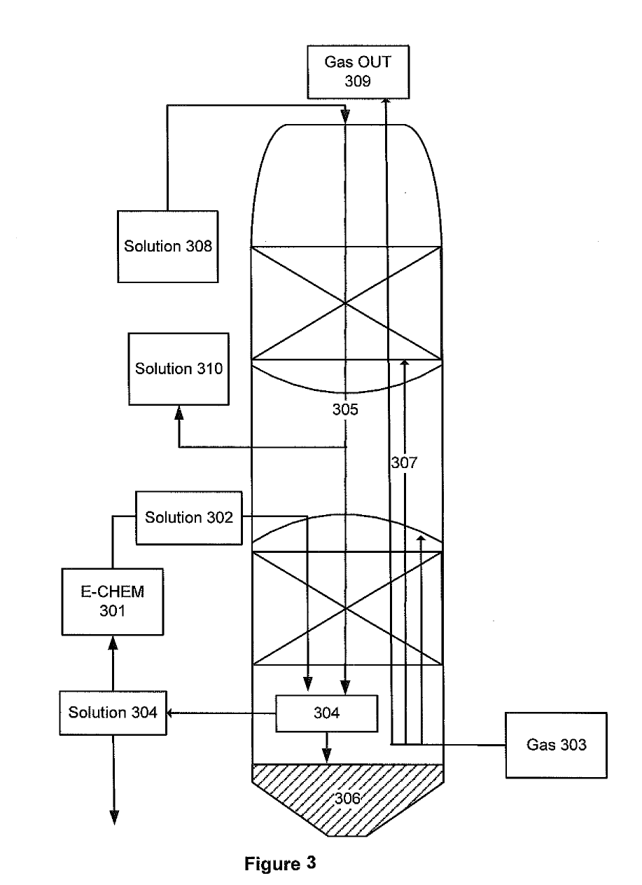

In FIG. 3 an embodiment of this invention is illustrated wherein an electrochemical method may be utilized to generate an alkaline solution for carbon dioxide sequestration. In some embodiments the electrochemical system 301 may generate a first alkaline solution 302 comprising carbonates that may react with a carbon dioxide containing gas 303 to form sequestered carbon dioxide in a first product solution (e.g., comprising bicarbonate) 304. In some embodiments the bicarbonate solution may be reacted with additional carbonate 305 to form a precipitated bicarbonate composition 306. A portion of the bicarbonate solution 304 may be separated and stored and/or a portion may be recycled into the electrochemical reaction 301 to regenerate the alkaline solution 302 for additional sequestration or storage. Gas containing unreacted carbon dioxide 307 may be further contacted with a second alkaline solution 308 to form a second product solution (e.g., comprising carbonate) 305. The carbonate containing solution may be removed 310 and stored or utilized. In an alternative embodiment a portion of the carbonate containing solution 305 may be further contacted with carbon dioxide containing gas to form additional bicarbonate solution 304.

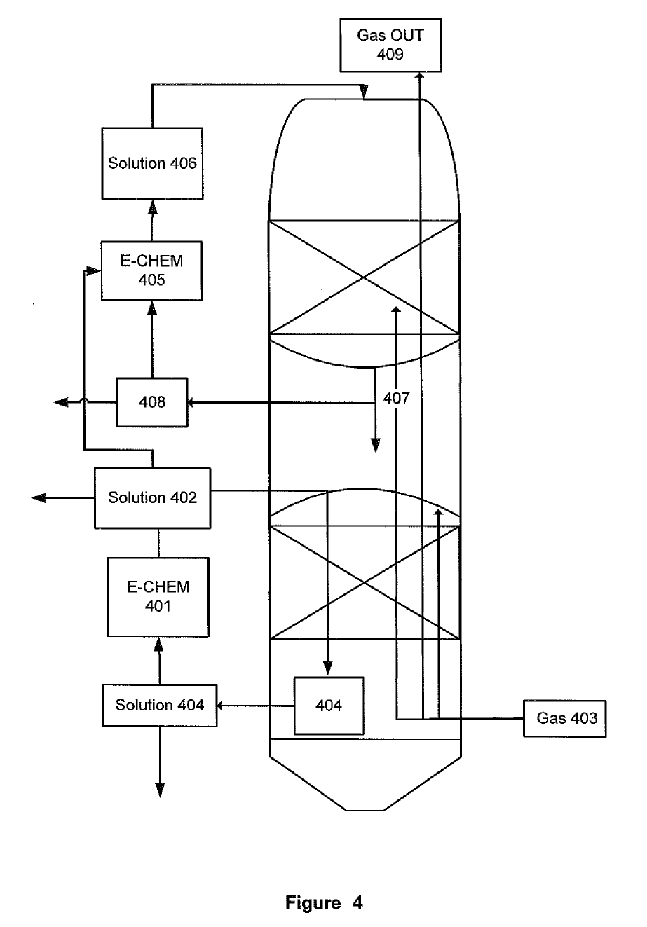

In some embodiments two or more electrochemical methods may be used to generate two or more alkaline solutions for contact with a carbon dioxide containing gas. In some embodiments two or more electrochemical systems may be configured to produce alkaline solutions at different pHs. This may advantageously reduce the overall energy consumption of the sequestration process while simultaneously providing a mechanism for regulating the composition of the sequestered carbon dioxide products. The electrochemical systems may be configured to generate the same or a different alkaline agent (e.g., hydroxide ion, carbonate ion). As illustrated in FIG. 4, a first electrochemical system 401 may generate a first alkaline solution 402 for contact with an incoming carbon dioxide containing gas 403. The contacting may comprise an acid-base reaction to generate a first product solution 404 comprising sequestered carbon dioxide solution (e.g., comprising bicarbonate, carbonate or any combination thereof). In some embodiments a portion of the sequestered carbon dioxide product solution may be recycled into the first electrochemical reaction 401 and a portion may be stored or utilized. In an alternative embodiment, the first alkaline solution 402 may be transferred to the second electrochemical reaction 405 in order to advantageously provide a reagent that may be utilized to generate a second alkaline solution 406 in the second electrochemical reaction 405. The second alkaline solution 406 generated by the second electrochemical reaction 405 may have a higher pH than the first alkaline solution 401 and be used to sequester carbon dioxide from the gas 407 that was not sequestered by the first alkaline solution 402. The carbon dioxide may be sequestered in any form such as a second product solution or slurry comprising carbonate, bicarbonate, on any combination thereof 408.

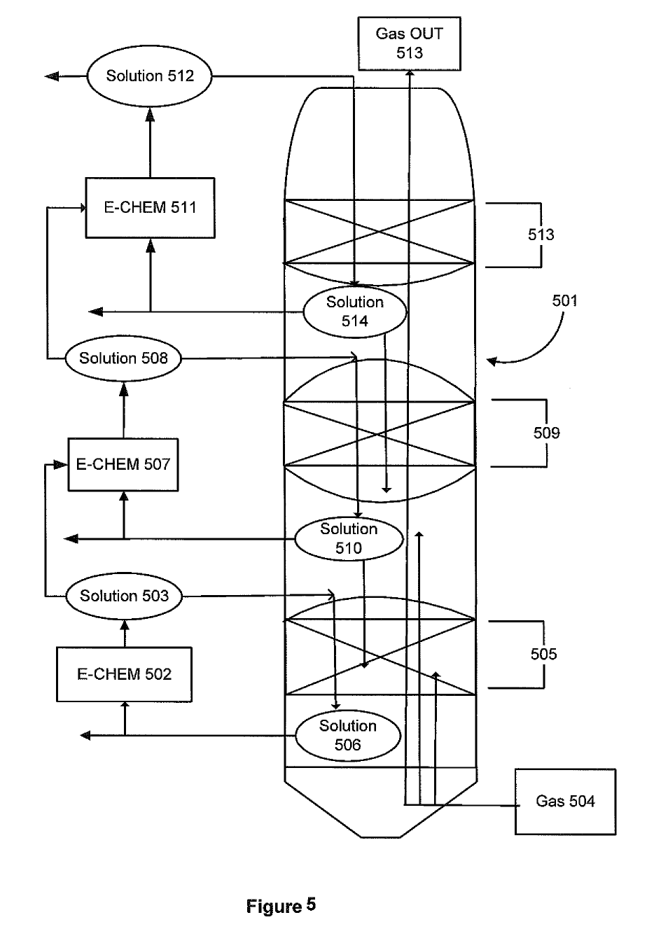

In other embodiments depicted in FIG. 5, multiple electrochemical methods may be utilized to generate multiple alkaline solutions for carbon dioxide sequestration in an absorption system 501. As illustrated, a first electrochemical system 502 may generate a first alkaline solution 503 for contact with a carbon dioxide containing gas 504 in first zone 505 of the absorption system 501. The contacting may comprise an acid-base reaction in the first zone 505 to generate a first product solution 506 comprising sequestered carbon dioxide (e.g., comprising bicarbonate, carbonate or any combination thereof). In some embodiments a portion of the first product solution 506 may be recycled into the first electrochemical reaction 502 and a portion may be stored or utilized. In an alternative embodiment, the first alkaline solution 503 may be transferred into a second electrochemical reaction 507 in order to advantageously lower the energy of generating a second alkaline solution 508 in the second electrochemical reaction 507. The second alkaline solution 508 generated by the second electrochemical reaction 507 may have a higher pH than the alkaline first solution 503 and be used to sequester carbon dioxide in a second zone 509 that was not sequestered by the first alkaline solution 503. The carbon dioxide may be sequestered in a second product solution 510. The carbon dioxide sequestered in the second product solution 510 may comprise bicarbonates, carbonates or any combination thereof. In some embodiments the bicarbonate:carbonate ratio in the second product solution 510 is lower that the bicarbonate:carbonate than the first product solution 506. In some embodiments the second product solution 510 may be removed from the absorption system 501 and stored or utilized. In some embodiments the second product solution 510 may be utilized to sequester additional carbon dioxide in the first zone 505. In some embodiments the second product solution 510 may be transferred back into the second electrochemical reaction 507. The carbon dioxide may be sequestered in any form such as a solution or slurry comprising carbonate, bicarbonate, on any combination thereof. In some embodiments the electrochemically generated second alkaline solution 508 may be utilized in a third electrochemical reaction 511. The third electrochemical reaction 511 may generate a third alkaline solution 512 for contact with the gas comprising carbon dioxide in a third zone 513. The third solution may have a higher pH than either the first or third solutions and therefore advantageously may sequester carbon dioxide not captured by the previous solutions contacted by the gas. The carbon dioxide may be sequestered in a third product solution 514 that may comprise a lower bicarbonate:carbonate ratio then the previous sequestered carbon dioxide product solutions 510 or 506. The third product 514 may be removed from the absorption system for storage and/or utilization. The third product solution 514 may be utilized to contact additional carbon dioxide in the second or first zones (505, 509).

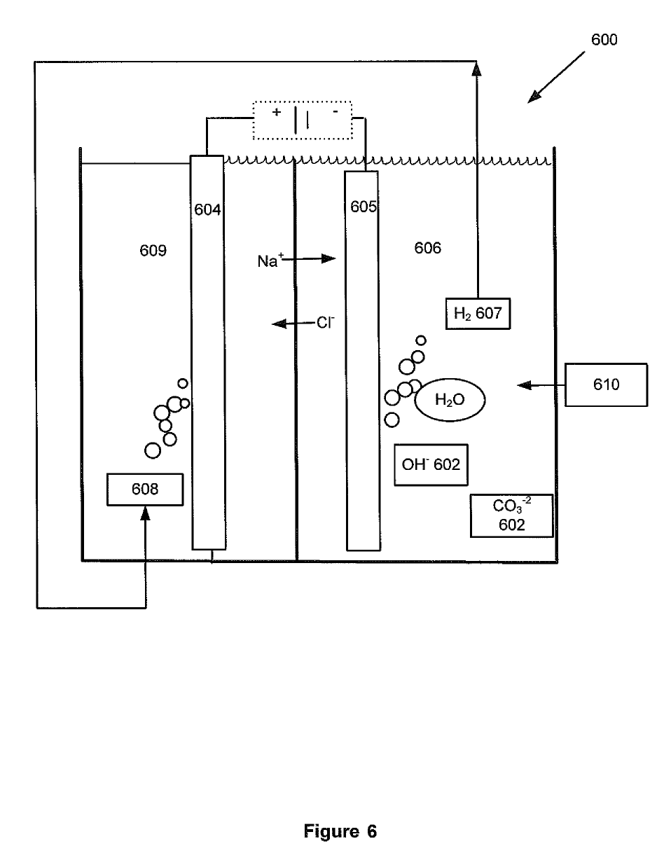

Any electrochemical method may be utilized in methods of this invention. In some embodiments alkaline hydroxides or carbonates may be produced electrochemically from an aqueous salt solution. An embodiment of a system is described with reference to FIG. 6 herein, a proton removing agent 602 (e.g., hydroxide, carbonate) is produced by an electrochemical system 600 wherein in one embodiment at the cathode 605, catholyte 606 is reduced to a proton removing agent 602 and hydrogen gas 607 that migrates into the catholyte 606. In some embodiments the hydrogen may be transferred to the anolyte 609 and at the anode 604, hydrogen gas 608 is oxidized. In some embodiments carbon dioxide or bicarbonate 610 is added to the catholyte to lower the cell voltage across the anode and cathode, and also to produce bicarbonate and/or carbonate solution with the catholyte. The carbon dioxide or bicarbonate may be added in a compartment separate from the cathode compartment when the compartments are operably connected

In some embodiments, an aqueous salt solution, e.g., sodium chloride or sodium sulfate solution is electrolyzed to produce the alkaline solution comprising hydroxide ions in the catholyte in contact with the cathode, and hydrogen gas at the cathode, while minimizing or eliminating the production of chlorine gas. Concurrently, protons produced by the oxidation at the anode migrate into the anolyte in contact with the anode to produce an acid, e.g., hydrochloric acid or sulfuric acid with cations from the salt solution. The system and method may be configured to operate at a voltage of 2.0 volts or less (e.g., 1.8 volts or less) applied across the anode and the cathode. Industrial amounts of an alkaline solution may be produced in electrochemical systems based on the chlor-alkali process or in a process that do not involve the generation of chlorine. Methods and systems used in sequestering carbon dioxide include sodium hydroxide produced in an electrochemical process e.g., from a sodium chloride solution or sodium sulfate. In one embodiment of the electrochemical process, as described in commonly assigned U.S. Pat. No. 7,790,012 herein incorporated by reference, sodium hydroxide is produced in the cathode compartment and migration of sodium ions from the salt solution into the cathode compartment to produce sodium hydroxide in the catholyte in contact with the cathode as shown in equation V.

2H₂O+2e⁻→H₂+2OH⁻ (Eq. V)

In some embodiments the co-product hydrogen gas produced at the cathode may be recovered and used at the anode 209 as described below. In the anode compartment, depending on which oxidation reaction occurs at the anode, either chlorine gas or hydrochloric acid may be produced based on equations VI and VII.

2Cl⁻→Cl₂+2e− (Eq. VI)

H₂→2H⁺+2e− (Eq. VII)

Where chlorine gas is produced as in Eq. VI, the gas can be recovered and used elsewhere; and where hydrogen is oxidized at the anode as in Eq. VII, the hydrogen gas produced at the cathode as in Eq. VI may be used at the anode. Alternatively, hydrogen from an exogenous source may be used. In some embodiments hydrogen is oxidized to protons at the anode under the applied overall cell voltage, the protons migrate into the anolyte in contact with the anode and combine with chloride ions to produce hydrochloric acid. As used herein, the anolyte is the electrolyte in contact with the anode, and the catholyte is the electrolyte in contact with the cathode; thus the anolyte may migrate or supply anions to or from the anode and similarly the catholyte can migrate or supply ions to or from the cathode.

One means by which the overall cell voltage may be reduced is not to produce a gas (e.g., chlorine, oxygen) at the anode, but rather to oxidize hydrogen at the anode to yield an acid. The methods of this invention provide for utilizing acid produced by an electrochemical process described here to advantageously further increase the economic efficiency of the process. In some embodiments, the hydrogen produced at the cathode may circulated to the anode to reduce the need for an external supply of hydrogen gas and hence reduce the overall energy utilized in the system to produce the alkaline solution.

In some embodiments, the sodium hydroxide is produced in the cathode electrolyte. When a voltage of less than 2 or less than 1.5, 1.4, 1.3, 1.2, 1.1, or 1.0 volts is applied across the cathode and anode. Concurrently, the hydrogen provided to the anode is oxidized to protons that migrate in the anolyte to produce an acid, e.g., hydrochloric acid or sulfuric acid in the anolyte. In methods of this invention utilization methods are described that may provide for increased economic efficiency of the electrochemical reaction.

In another embodiment, the present hydrogen anode assembly is described in greater detail in U.S. Pat. No. 5,595,641, titled: “Apparatus and Process for Electrochemically Decomposing Salt Solutions to form the Relevant Base and Acid”, herein incorporated by reference. In some embodiments, an electrolyzer comprising at least one elementary cell divided into electrolyte compartments by cation-exchange membranes, wherein said compartments are provided with a circuit for feeding electrolytic solutions and a circuit for withdrawing electrolysis products, and wherein said cell is equipped with a cathode and a hydrogen-depolarized anode assembly forming a hydrogen gas chamber fed with a hydrogen-containing gaseous stream, characterized in that said assembly comprises a cation-exchange membrane, a porous, flexible electrocatalytic sheet, a porous rigid current collector having a multiplicity of contact points with said electrocatalytic sheet, said membrane, sheet and current collector are held in contact together by means of pressure without bonding.

### Precipitation

Methods of the invention include contacting a volume of an aqueous solution of divalent cations with a source of sequestered carbon dioxide (e.g., carbonic acid, bicarbonate, and/or carbonate) in a product solution and subjecting the resultant solution to precipitation conditions. In addition to divalent cations sourced from acid neutralizing material, divalent cations may come from any of a number of different divalent cation sources depending upon availability at a particular location. Material comprising divalent cations may also be used in combination with supplemental sources of divalent cations. Such sources include industrial wastes, seawater, subterranean brines, hard waters, minerals (e.g., lime, periclase), and any other suitable source.

In methods of the invention, a volume of CO₂-charged product solution produced as described above may be subjected to carbonate compound precipitation conditions sufficient to produce a carbonate-containing precipitation material and a supernatant (i.e., the part of the precipitation reaction mixture that is left over after precipitation of the precipitation material). Any convenient precipitation condition may be employed, in which conditions result in production of a carbonate-containing precipitation material. In some embodiments the materials may comprise divalent cations from a metal silicate (optionally with SiO₂) from the CO₂-charged reaction mixture. Precipitation conditions include those that modulate the physical environment of the CO₂-charged precipitation reaction mixture to produce the desired precipitation material. For example, the temperature of the CO₂-charged precipitation reaction mixture may be raised to a point at which precipitation of the desired carbonate-containing precipitation material occurs, or a component thereof (e.g., CaSO₄(s), the sulfate resulting from, for example, sulfur-containing gas in combustion gas or sulfate from seawater). In such embodiments, the temperature of the CO₂-charged precipitation reaction mixture may be raised to a value from 5° C. to 70° C., such as from 20° C. to 50° C., and including from 25° C. to 45° C. While a given set of precipitation conditions may have a temperature ranging from 0° C. to 100° C., the temperature may be raised in certain embodiments to produce the desired precipitation material. In certain embodiments, the temperature of the precipitation reaction mixture is raised using energy generated from low or zero carbon dioxide emission sources (e.g., solar energy source, wind energy source, hydroelectric energy source, waste heat from the flue gases of the carbon dioxide emitter, etc.). In some embodiments, the temperature of the precipitation reaction mixture may be raised utilizing heat from flue gases from coal or other fuel combustion. Pressure may also be modified. In some embodiments, the pressure for a given set of precipitation conditions is normal atmospheric pressure (about 1 bar) to about 50 bar. In some embodiments, the pressure for a given set of precipitation materials is 1-2.5 bar, 1-5 bar, 1-10 bar, 10-50 bar, 20-50 bar, 30-50 bar, or 40-50 bar. In some embodiments, precipitation of precipitation material is performed under ambient conditions (i.e., normal atmospheric temperature and pressure). The pH of the CO₂-charged precipitation reaction mixture may also be raised to an amount suitable for precipitation of the desired carbonate-containing precipitation material. In such embodiments, the pH of the CO₂-charged precipitation reaction mixture is raised to alkaline levels for precipitation, wherein carbonate is favored over bicarbonate. The pH may be raised to pH 9 or higher, such as pH 10 or higher, including pH 11 or higher. For example, when a proton-removing agent source such as fly ash is used to raise the pH of the precipitation reaction mixture or precursor thereof, the pH may be about pH 12.5 or higher.

Accordingly, a set of precipitation conditions to produce a desired precipitation material from a precipitation reaction mixture may include, as above, the temperature and pH, as well as, in some instances, the concentrations of additives and ionic species in solution. Precipitation conditions may also include factors such as mixing rate, forms of agitation such as ultrasonic agitation, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate-containing precipitation material according to the invention (from start to finish [e.g., drying precipitation material or forming precipitation material into pozzolanic material]) may be batch, semi-batch, or continuous protocols. It will be appreciated that precipitation conditions may be different to produce a given precipitation material in a continuous flow system compared to a semi-batch or batch system.

Carbonate-containing precipitation material, following production from a precipitation reaction mixture, may be separated from the reaction mixture to produce separated precipitation material (e.g., wet cake) and a supernatant. Precipitation material according to the invention may contain SiO₂; however, if silicon-based material was separated after digestion of material comprising metal silicates, the precipitation may contain very little or no SiO₂. The precipitation material may be stored in the supernatant for a period of time following precipitation and prior to separation (e.g., by drying). For example, the precipitation material may be stored in the supernatant for a period of time ranging from 1 to 1000 days or longer, such as 1 to 10 days or longer, at a temperature ranging from 1° C. to 40° C., such as 20° C. to 25° C. Separation of the precipitation material from the precipitation reaction mixture is achieved using any of a number of convenient approaches, including draining (e.g., gravitational sedimentation of the precipitation material followed by draining), decanting, filtering (e.g., gravity filtration, vacuum filtration, filtration using forced air), centrifuging, pressing, or any combination thereof. Separation of bulk water from the precipitation material produces a wet cake of precipitation material, or a dewatered precipitation material. As detailed in U.S. 61/170086, filed Apr. 16, 2009, which is herein incorporate by reference, use of liquid-solid separators such as Epuramat's Extrem-Separator (“ExSep”) liquid-solid separator, Xerox PARC's spiral concentrator, or a modification of either of Epuramat's ExSep or Xerox PARC's spiral concentrator, provides for separation of the precipitation material from the precipitation reaction mixture.

In some embodiments, the resultant dewatered precipitation material may then dried to produce a product (e.g., a cement, or a a pozzolanic cement). Drying may be achieved by air-drying the precipitation material. Where the precipitation material is air dried, air-drying may be at a temperature ranging from −70° C. to 120° C. In certain embodiments, drying is achieved by freeze-drying (i.e., lyophilization), wherein the precipitation material is frozen, the surrounding pressure is reduced, and enough heat is added to allow the frozen water in the precipitation material to sublime directly into gas. In yet another embodiment, the precipitation material is spray-dried to dry the precipitation material, wherein the liquid containing the precipitation material is dried by feeding it through a hot gas (e.g., a gaseous waste stream from the power plant), and wherein the liquid feed is pumped through an atomizer into a main drying chamber and a hot gas is passed as a co-current or counter-current to the atomizer direction. Depending on the particular drying protocol, the drying station (described in more detail below) may be configured to allow for use of a filtration element, freeze-drying structure, spray-drying structure, etc. In certain embodiments, waste heat from a power plant or similar operation may be used to perform the drying step when appropriate. For example, in some embodiments, aggregate is produced by the use of elevated temperature (e.g., from power plant waste heat), pressure, or a combination thereof

Following separation of the precipitation material from the supernatant, the separated precipitation material may be further processed as desired; however, the precipitation material may simply be transported to a location for long-term storage, effectively sequestering CO₂. For example, the carbonate-containing precipitation material may be transported and placed at a long-term storage site, for example, above ground (as a storage-stable CO₂-sequestering material), below ground, in the deep ocean, etc.

In some embodiments divalent cations may be contacted with sequestered carbon dioxide to produce precipitation material. In some embodiments, the method further comprises separating the precipitation material from the supernatant with a liquid-solid separator, drying the precipitation material, processing the precipitation material to produce a construction material, or a combination thereof. As such, in some embodiments, the method further comprises separating the precipitation material from the supernatant with a liquid-solid separator. In such embodiments, the liquid-solid separator is selected from a liquid-solid separator comprising a baffle such as Epuramat's Extrem-Separator (“ExSep”) liquid-solid separator. For example, in some embodiments, precipitation material is separated from precipitation reaction mixture by flowing the reaction mixture against a baffle, against which supernatant deflects and separates from particles of precipitation material, which is collected in a collector. In some embodiments, the liquid-solid separator is selected from a liquid-solid separator comprising a spiral concentrator such as Xerox PARC's spiral concentrator. For example, in some embodiments, precipitation material is separated from precipitation reaction mixture by flowing the reaction mixture in a spiral channel separating particles of precipitation material from supernatant and collecting the precipitation material in an array of spiral channel outlets. In some embodiments, the method further comprises drying the precipitation material. In such embodiments, the precipitation material may be dried to form a fine powder having a consistent particle size (i.e., the precipitation material may have a relatively narrow particle size distribution). Precipitation material, as described further herein, may have a Ca²⁺ to Mg²⁺ ranging from 1:1000 to 1:1 or 1 to 1000:1. Precipitation material comprising MgCO₃ may comprise magnesite, barringtonite, nesquehonite, lansfordite, amorphous magnesium carbonate, artinite, hydromagnesite, or a combination thereof. Precipitation material comprising CaCO₃ may comprise calcite, aragonite, vaterite, ikaite, amorphous calcium carbonate, monohydrocalcite, or combinations thereof. In some embodiments the precipitation material may be greater that 50% vaterite. In some embodiments, the method further comprises processing the precipitation material to produce a construction material. In such embodiments, the construction material is an aggregate, cement, cementitious material, supplementary cementitious material, or a pozzolan.

### Systems

Where the CO₂ is a gas, it may be sequestered by contact protocols of interest that include, but are not limited to direct contacting protocols (e.g., bubbling the CO₂ gas through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, as may be convenient. In some embodiments, gas-liquid contact is accomplished by forming a liquid sheet of solution with a flat jet nozzle, wherein the CO₂ gas and the liquid sheet move in countercurrent, co-current, or crosscurrent directions, or in any other suitable manner. In some embodiments the contact liquid is an alkaline solution. In some embodiments the alkaline solution is generated from an electrochemical reaction that is configured to generate no chlorine gas or no gas at the anode. In some embodiments, gas-liquid contact is accomplished by nebulizing a precursor to the precipitation reaction mixture such that contact is optimized between droplets of the precipitation reaction mixture precursor an a source of CO₂. In some embodiments, gas-liquid contact is accomplished by contacting liquid droplets of solution having an average diameter of 500 microns or less, such as 100 microns or less, with the CO₂ gas source. In some embodiments, a catalyst is used to accelerate the dissolution of carbon dioxide into solution by accelerating the reaction toward equilibrium; the catalyst may be an inorganic substance such as zinc dichloride or cadmium, or an organic substance such as an enzyme (e.g., carbonic anhydrase). In some embodiments the system and methods may include devices and/or solutions for removing contaminates other than carbon dioxide from a gas stream. The system and methods may include solutions for removing contaminates in one or more absorbing zones.

In some embodiments a gas comprising carbon dioxide is contacted with an alkaline first solution and an alkaline second solution using a gas-liquid contacting apparatus (i.e., absorber). The absorber in the carbon dioxide contacting system may be a packed bed absorber with two or more zones of gas-liquid contact. In some embodiments two or more absorbers may be utilized to house two or more zones of contact. An exemplary method and system for contacting a gaseous stream employs contacting the gaseous stream to a first stream of the first alkaline contacting solution in the first zone, followed by contacting the gaseous stream to a second stream of the second alkaline solution in a second zone. Thus in some embodiments the invention provides an apparatus for separating carbon dioxide from an industrial waste stream that comprises a gas-liquid contactor that is configured to contact two or more streams of a liquid, e.g., alkaline solutions, with all or a portion of the industrial waste gas stream to dissolve CO₂ in two or more zones of contact. The liquid streams may be the same or different. The liquid streams may be the same or different pHs. In some embodiments the system may comprise a unit operably connected to the gas-liquid contactor for removing sequestered carbon dioxide after contact in the first and or second zone of contact. In some embodiments, the sequestered carbon dioxide comprises bicarbonates, carbonates or any combination thereof. In some embodiments, a solid composition is generated that comprises carbonates and/or bicarbonates and also one or more further components of the industrial waste gas, e.g., SOx or a SOx derivative, NOx or a NOx derivative, a heavy metal or derivative thereof, particulates, VOCs or a VOC derivative, or a combination thereof.

U.S. Pat. No. 7,379,487 describes an exemplary flat jet stream/gas contacting system, the disclosure of which is herein incorporated by reference. In some embodiments, contacting a gaseous stream comprising CO2 comprises use of the two-phase reactor as described in U.S. Pat. No. 7,379,487. A brief description of the flat jet stream methods and system is provided below. In many gas-liquid contacting systems the rate of gas transport to the liquid phase is controlled by the liquid phase mass transfer coefficient, k, the interfacial surface area, a, and the concentration gradient, ΔC, between the bulk fluid and the gas-liquid interface. A practical form for the rate of gas absorption into the liquid is then:

Φ=φa=kGa(p−pi)=kLa(CL*−CL)

where Φ is the rate of gas absorption per unit volume of reactor (mole/cm³·s), a is the average rate of absorption per unit interfacial area (mole/cm² s), a is the gas liquid interfacial area per unit volume (cm²/cm³, or cm-1), p and pi are the partial pressures (bar) of reagent gas in the bulk gas and at the interface, respectively, CL* is the liquid side concentration (mole/cm³) that would be in equilibrium with the existing gas phase concentration, pi, and CL (mole/cm³)is the average concentration of dissolved gas in the bulk liquid. kG and kL are gas side and liquid side mass transfer coefficients (cm³/s), respectively.

In many gas-liquid reaction systems the solubility of the CL* is very low and control of the concentration gradient is therefore limited. Thus, the primary parameters to consider in designing an efficient gas-liquid flow reactor are mass transfer and the interfacial surface area to reactor volume ratio, which is also known as the specific surface area. In certain embodiments, the flat jet gas-liquid contacting system of the invention is a gas-liquid contacting system that uses the enhanced specific surface area of a flat jet to improve the interaction between the CO₂-containing gaseous streams with the water, e.g., alkaline earth metal ion-containing water. In certain embodiments, a rigid nozzle plate containing a plurality of orifices that generate very thin flat jets is employed. The flat jet orifice has in one configuration a V-shaped chamber attached to the source of the water, e.g., alkaline earth metal ion-containing water. The flat jet orifice may have a pair of opposing planar walls attached to a vertex of the V-shaped chamber. The flat jet nozzle may have a conical nozzle attached to an opposite end of the opposing planar walls as the V-shaped chamber. In another configuration, the jet orifice may have a circular orifice attached to the liquid source chamber. The flat jet nozzle may have a V-shaped groove intersecting the circular orifice to create an oval shaped orifice. The flat jet orifice may be oriented perpendicularly, opposed, or parallel to the inlet source of the CO₂-containing gaseous stream. A smallest passage of the flat jet nozzles may be larger than 600 microns. The nozzle may produce a liquid flat jet that has a width that is at least ten times its thickness, or at least 8 times its thickness, or at least 6 times its thickness, or at least 4 times its thickness. The flat jets may be made as thin as 10 microns, e.g., 10-15 microns, 10-20 microns, or 10-40 microns, and be separated by less than 1.1, 1.0, 0.9, 0.8, 0.7, 0.6, 0.5, 0.4, 0.3, or 0.2 mm, e.g., less than 1 millimeter to generate high packing jet densities (β=0.01) and large specific surface areas, a=10-20 cm-1. The thin jet allows more of the absorbing solution to be exposed to the CO₂-containing gaseous stream, generating a higher yield of reaction product per unit liquid mass flow than conventional contactors, e.g., greater transfer of CO₂ and/or other components of the gas stream, such as SOx, NOx, heavy metals, particulates, VOCs, and derivatives and combinations thereof, to the liquid, e.g., alkaline solution.

In some embodiments of the invention shed rows are used. Shed rows may be configured to maximize the distribution of gas in the absorber by convoluting the flow gas. This may advantageously maximize the gas distribution and liquid-gas contact throughout the absorbing system. In some embodiments at least one array of shed rows within the absorber are configured to redistribute the flow of the gas as it enters the absorber such that the gas flows axially along the chamber over a greater area of the cross section of the chamber than the gas flow upon entering the chamber, prior to interacting with the shed rows. In some embodiments of the invention the apparatus comprises two or more arrays of sprays. The sprays may be made in any convenient manner including using eductor or educator-jet nozzles, dual fluid nozzles, a pressure atomizer, a rotary atomizer, an air-assist atomizer, an airblast atomizer, or an ultrasonic atomizer or any combination thereof The flow of the gas in the apparatus is upwards, so that all of the sprays encounter the gas flow in a counter-current fashion. The gas enters the apparatus at the bottom and flows up the length of the apparatus. The apparatus may include a demisting section positioned before the gas outlet (not shown). The absorbing solution or contacting mixture may be clear liquid or it may be a slurry that contains a solid component such as a mineral, industrial waste (e.g., fly ash, cement kiln dust), and/or a precipitated material if recirculation is employed. In the case that recirculation is employed, comminution of any solids in the absorbing solution may occur. The absorbing solution or contacting mixture may include industrial waste brine, naturally occurring alkaline brine, seawater, artificially composed or synthetic brine, or any combination thereof.

In some embodiments of the invention, the apparatus comprises an array of sprays. The topmost spray may be configured to release the highest pH liquid. The bottom-most spray may be configured to release the lowest pH liquid. The gas may enter the apparatus at the bottom and flows up the length of the apparatus. The apparatus may include one or more shed rows in addition to the sprays in the absorbing zones of the apparatus. The apparatus may include chimney trays situated between zones of carbon dioxide absorption. Chimney trays may advantageously be used to separate carbon dioxide sequestered in a liquid from gaseous carbon dioxide. The apparatus may include a demisting section positioned before the gas outlet. The absorbing solution may be clear liquid or it may be a slurry that contains a solid component such as a mineral, industrial waste (e.g., fly ash, cement kiln dust), and/or a precipitated material if recirculation is employed. In the case that recirculation is employed, comminution of any solids in the absorbing solution may occur.

In some embodiments the sheds may be staggered such that liquid falling from the upper sheds will arrive near the apex of the sheds below. The sheds may be staggered, such that liquid falling from the upper sheds will arrive near the apex of the sheds below. The bottom-most configuration of shed rows are configured such that instead of all of the sheds being aligned parallel to each other through the entire height of the chamber or column, every other level of sheds are oriented 90° to the row above and below.

In some embodiments, the apparatus and systems of the invention are configured to incorporate more than 20 tons/hour of carbon dioxide into an absorbing solution as averaged over 72 hours of continuous operation. In some embodiments, the apparatus and systems of the invention are configured to incorporate more than 40 tons/hour of carbon dioxide into an absorbing solution. In some embodiments, the apparatus and systems of the invention are configured to incorporate more than 60 tons/hour of carbon dioxide into an absorbing solution. In some embodiments, the apparatus and systems of the invention are configured to incorporate more than 70 tons/hour of carbon dioxide into an absorbing solution. In some embodiments, the apparatus and systems of the invention are configured to incorporate more than 80 tons/hour of carbon dioxide into an absorbing solution. In some embodiments, the apparatus and systems of the invention are configured to incorporate more than 90 tons/hour of carbon dioxide into an absorbing solution. In some embodiments, the apparatus and systems of the invention are configured to incorporate more than 100 tons/hour of carbon dioxide into an absorbing solution. In some embodiments, the apparatus and systems of the invention are configured to incorporate more than 110 tons/hour of carbon dioxide into an absorbing solution. In some embodiments, the apparatus and systems of the invention are configured to incorporate more than 120 tons/hour of carbon dioxide into an absorbing solution. In some embodiments, the apparatus and systems of the invention are configured to incorporate more than 130 tons/hour of carbon dioxide into an absorbing solution. In some embodiments the apparatus and systems of the invention are configured to incorporate more than 140 tons/hour of carbon dioxide into an absorbing solution. In some embodiments, the apparatus and systems of the invention are configured to incorporate more than 150 tons/hour of carbon dioxide into an absorbing solution. In some embodiments the apparatus and systems of the invention are configured to incorporate more than 160 tons/hour of carbon dioxide into an absorbing solution. In some embodiments, the apparatus and systems of the invention are configured to incorporate more than 170 tons/hour of carbon dioxide into an absorbing solution. In some embodiments, the apparatus and systems of the invention are configured to incorporate more than 180 tons/hour of carbon dioxide into an absorbing solution. In some embodiments, the apparatus and systems of the invention are configured to incorporate more than 190 tons/hour of carbon dioxide into an absorbing solution. In some embodiments, the apparatus and systems of the invention are configured to incorporate more than 200 tons/hour of carbon dioxide into an absorbing solution.

Systems for performing methods of this invention include an electrochemical system configured to generate an acidic solution in a compartment and an alkaline solution in a separate compartment. Each compartment may be operably connected to separate conduits for transporting the acidic solution and the alkaline solution. In some embodiments the acid transfer conduit may be suitable for the transfer an acidic solution with a pH less than 2 or less than 1.3. The electrochemical system may be suitable for generating an acidic solution and an alkaline solution but may not be suitable for the production of a gas such as chlorine gas (e.g., the system may utilize a hydrogen gas diffusion anode). The electrochemical system may operate at 2 volts (V) or less. In some embodiments the electrochemical reaction may proceed after a voltage of less than 2 or less than 1.8 or less than 1.5 volts is applied between the anode and the cathode.

The conduits and vessels may be made or coated with the appropriate materials for allowing the processes to occur in a corrosion resistant manner. In some embodiments the conduits may be configured to transport an acidic solution with a pH of less than 0, or 0.5 or 1.0 or 1.3, or 2.0. In some embodiments the conduits may be configured to transport alkaline solutions with a pH of greater than 8, or 9, or 10, or 11, or 12, or 13. In some embodiments the conduits may be insulated in order minimize heat loss in the acidic or alkaline solutions. In some embodiments the electrochemical system may be configured to not release chlorine gas.

The absorption vessel may be operably connected to a precipitation reaction vessel. The precipitation reaction vessel may be further configured for adjusting and controlling precipitation reaction conditions such as one or more precipitation control systems. For example, the precipitation reaction vessel may have a temperature probe and heating element, both of which may be used to control the temperature of the precipitation reaction mixture. A liquid-solid separator may be operably connected to the precipitation reaction vessel and configured to receive precipitation reaction mixture from the precipitation reaction vessel. The liquid-solid separator may be further configured to separate the precipitation reaction mixture into two streams, which streams comprise supernatant and precipitation material. The resultant precipitation material may be a relatively moist solid or a slurry more rich in precipitation material than the original precipitation reaction mixture, either of which may optionally be provided to a dryer configured to receive concentrated precipitation material.

A dryer (e.g., spray dryer), which may accept waste heat from the industrial waste source of CO₂, may produce a dried precipitation or pozzolanic material. The source of the waste gas operably connected to a precipitation reactor and or the dryer may be, in some embodiments, a fossil fuel-fired power plant, a refinery, or some other industrial process that emits an exhaust gas with an elevated concentration of CO₂ relative to the atmospheric level of CO₂. In some embodiments, such exhaust gas is produced by a combustion reaction and therefore the exhaust gas carries residual heat from the combustion reaction. If the distance from the source of the exhaust gas is extensive, or if the exhaust gas is otherwise not sufficiently hot for the purpose of spray drying, a gas heating unit may be placed between the source of the exhaust gas and the spray dryer to boost the temperature of the exhaust gas. It will be appreciated that, in addition to oxidizing exhaust gases produced by combustion, the source of the exhaust gas may be replaced with a source of a reducing gas such as syngas, shifted syngas, natural gas, hydrogen, or the like, so long as the reducing gas includes CO₂. Other suitable multi-component gaseous streams include turbo charged boiler product gas, coal gasification product gas, shifted coal gasification product gas, anaerobic digester product gas, wellhead natural gas streams, reformed natural gas or methane hydrates, and the like.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any design features developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method comprising:
a. contacting an incoming gas comprising carbon dioxide at a first concentration with a first alkaline solution under conditions promoting an acid-base reaction between the carbon dioxide and the first alkaline solution to form a first product solution and an intermediate gas comprising carbon dioxide at a second concentration that is less than the first concentration;
b. contacting the intermediate gas with a second alkaline solution under conditions that promote an acid-base reaction between the carbon dioxide and the second alkaline solution to form a second product solution and a product gas wherein the product gas comprises less carbon dioxide than the intermediate gas; and
c. wherein the pH of the second alkaline solution is greater than the pH of the first alkaline solution.

2. A method comprising:
a. contacting an incoming gas comprising carbon dioxide at a first concentration with a first alkaline solution under conditions promoting an acid-base reaction between the carbon dioxide and the first alkaline solution to form a first product solution and an intermediate gas comprising carbon dioxide at a second concentration that is less than the first concentration;
b. contacting the intermediate gas with a second alkaline solution under conditions that promote an acid-base reaction between the carbon dioxide and the second alkaline solution to form a second product solution and a product gas wherein the product gas comprises less carbon dioxide than the intermediate gas; and
c. wherein the first or second solution comprises a component for sequestering NOx, SOx, Hg, ammonia, hydrogen chloride or any combination thereof

3. The method of claim 1, wherein the contacting of the incoming gas and the intermediate gas occurs in the same reaction vessel.

4. The method of claim 1, wherein the first and second alkaline solutions are substantially free of amines.

5. The method of claim 1, further comprises forming a precipitation material from the first, second or both of the product solutions.

6. The method of claim 5, wherein forming a precipitation material comprises contacting the first or second product solution with a carbonate solution.

7. The method of claim 5, wherein forming a precipitation material comprises contacting the first or second product solution with a divalent cation solution.

8. The method of claim 5, wherein forming a precipitation material comprises adjusting the pH of the first or second product solution.

9. The method of claim 5, wherein forming a precipitation material comprises adjusting the temperature of the first or second product solution.

10. The method of claim 1, wherein the first and second alkaline solution are provided by a first and second electrochemical reaction.

11. A system comprising:
a. a gas liquid absorber comprising a first and second absorbing zone;
i. wherein the first absorbing zone is adapted to withstand alkaline conditions and is operably connected to a source of gas comprising carbon dioxide and a source of a first alkaline solution and wherein the zone is configured contact a source of gas comprising carbon dioxide with the first solution to form a first product solution and an intermediate gas comprising carbon dioxide and wherein the first zone comprises a first gas outlet for the intermediate gas and a first solution outlet for the first product solution;
ii. wherein the second absorbing zone is adapted to withstand alkaline conditions and is operably connected the to the outlet for the intermediate gas and a source of a second alkaline solution and wherein the second zone is configured contact the intermediate gas comprising carbon dioxide with the second alkaline solution to form product gas and a second product solution and wherein the second absorbing zone comprises a second gas outlet for the product gas and a second solution outlet for the second product solution.

12. The system of claim 11, wherein the first solution outlet is operably connected to a precipitation station.

13. The system of claim 11, wherein the second solution outlet is operably connected to a precipitation station.

14. The system of claim 11, further comprising a first and second pump wherein the first pump is operably connected to the first source of alkaline solution and the second pump is operably connected to the second alkaline solution.

15. The system of claim 11, wherein the first absorbing zone comprises a packed bed.

16. The system of claim 11, wherein the second absorbing zone comprises a packed bed.

17. The system of claim 11, further comprising a first electrochemical system for providing the first alkaline solution and operably connected to the first absorbing zone.

18. The system of claim 11, further comprising an electrochemical system for providing the second alkaline solution and operably connected to the second absorbing zone.

19. The system of claim 18, further comprising a second electrochemical system for providing the second alkaline solution and operably connected to the second absorbing zone.

20. The system of claim 19, wherein the first and second electrochemical systems are in fluid communication outside of the absorber.
